(19) United States
(12) Patent Application Publication
(10) Pub. No.: US 2005/0254424 A1
(43) Pub. Date: Nov. 17, 2005

(54) Method for determining IT resource allocation

(75) Inventors: Ken Naono, Tachikawa (JP); Shunji Takubo, Kodaira (JP); Masashi Egi, Kokubunji (JP)

Correspondence Address: Stanley P. Fisher;Reed Smith LLP, 3110 Fairview Park Drive, Suite 1400, Falls Church, VA, 22042-4503, US

(73) Assignee: Hitachi, Ltd.

(21) Appl. No.: 11/034,068

(22) Filed: Jan. 13, 2005

(30) Foreign Application Priority Data
Apr. 22, 2004 (JP) 2004-126851

(51) Int. Cl. H04L 1/00

(52) U.S. Cl. 370/231

(57) ABSTRACT

An IT system is operated reflecting a management policy accurately. In a method for determining allocation of IT resources of an IT system shared by divisional operations of an organization based on management resources allocation among divisions in the organization, the method comprises a first and a second steps of resource allocation. In the first step, management resource allocation for each of the divisional operations is determined so as to optimize a value of an operational objective based on the assumption that IT resource allocation is equal among the divisional operations and based on the management resource allocation among the divisions of the organization. In the second step, IT resource allocation for each of the divisional operations is determined so as to optimize the operational objective value based on the management resource allocation for each of the divisional operations determined in the first step.

### CLAIM OF PRIORITY

The present application claims priority from Japanese application P2004-126851 filed on Apr. 22, 2004, the content of which is hereby incorporated by reference into this application.

### BACKGROUND OF THE INVENTION

The present invention relates to a method for determining IT resource allocation and, more particularly, to a method and a computer system for determining IT (Information Technology) resource allocation reflecting a management policy.

In recent years, IT systems have been important in business activities. Individual enterprises are desired to carry out management flexibly changing their management policy to cope with rapid social change. To enable such management, it is necessary for each enterprise to coordinate operations of its divisions and then determine an integrated management policy.

In the circumstances as described above, methods and tools for assessing the effects of investment in IT systems are being studied. A known example among such methods and tools is a unit which computes, using financial statements as input data, such indicators as equipment-related income and expenditure, operational cash flow, securities income and expenditure, and borrowing, and graphically displays required data selected from the results of the computation. Using such a unit makes it possible to visually grasp variation over years in, for example, IT-related capital investment and operational cash flow, assess the effects of capital investment on the operational cash flow, and present material helpful in determining the advisability of equipment investment (refer to JP 2001-188827 A).

Software for quickly diagnosing computerization has also been known. Such software provides a technique for grasping an outline of and problems in the operational process of an enterprise through a preliminary survey of the enterprise and direct interviews of personnel at the enterprise, categorizing the direction of computerization to be promoted, and presenting diagnostic results and solutions concerning operational process efficiency, the current state of computerization, computerization promoting system, and performance management at the enterprise. Using such a technique enables an enterprise to obtain a guideline for computerization investment to be considered based on the current state of operational process of the enterprise (refer to JP 2002-352060 A).

### SUMMARY OF THE INVENTION

Coordinating divisional operations of an enterprise by use of an IT system can bring about improvement in the operational efficiency of the enterprise. In an enterprise, redefining the system used in each division and making an IT system compatible with the management policy of each division used to involve an enormous amount of adjustment work between divisions. Inadequate adjustment work between divisions used to result in inefficient IT system operation.

It is an object of the present invention to operate an IT system precisely reflecting a management policy.

The present invention has been made in view of the above circumstances and provides a first and a second steps in a method for determining, based on the allocation of management resources of an organization among divisions thereof, allocation of IT resources of an IT system shared among divisional operations of the organization. The first step includes determining the management resources allocation of the divisional operations, so as to optimize a value of an operational objective, based on the allocation of the management resources among the divisions and based on the assumption that the IT resources are evenly allocated to the divisional operations. The second step includes determining the IT resource allocation of the divisional operations, so as to optimize the value of the operational objective, based on the management resource allocation to the divisional operations determined in the first step.

According to an embodiment of the present invention, an information system can be operated to effectively support the operation of each division of an enterprise reflecting the operational policy of each division even in a case in which the management policy of the enterprise is changed.

### BRIEF DESCRIPTION OF THE DRAWINGS

The present invention can be appreciated by the description which follows in conjunction with the following figures, wherein:

FIG. 1 is a block diagram showing a configuration of an embodiment of the present invention;

FIG. 2 is a flowchart showing an example of operational process performed in a computer system according to an embodiment of the present invention;

FIG. 3 is a sequence diagram showing an example of information flow during task execution in a computer system according to an embodiment of the present invention;

FIG. 4 is a flowchart showing how an IT policy is determined in a computer system according to an embodiment of the present invention;

FIG. 5 is a diagram for explaining an operational objective function according to an embodiment of the present invention;

FIG. 6 is a chart for explaining parameters of a management policy, an operational policy, and an IT policy according to an embodiment of the present invention;

FIG. 7 is a diagram for explaining a first policy transformation according to an embodiment of the present invention; and

FIG. 8 is a diagram for explaining a second policy transformation according to an embodiment of the present invention.

### DESCRIPTION OF THE PREFERRED EMBODIMENTS

Embodiments of the present invention will be described with reference to the accompanying drawings.

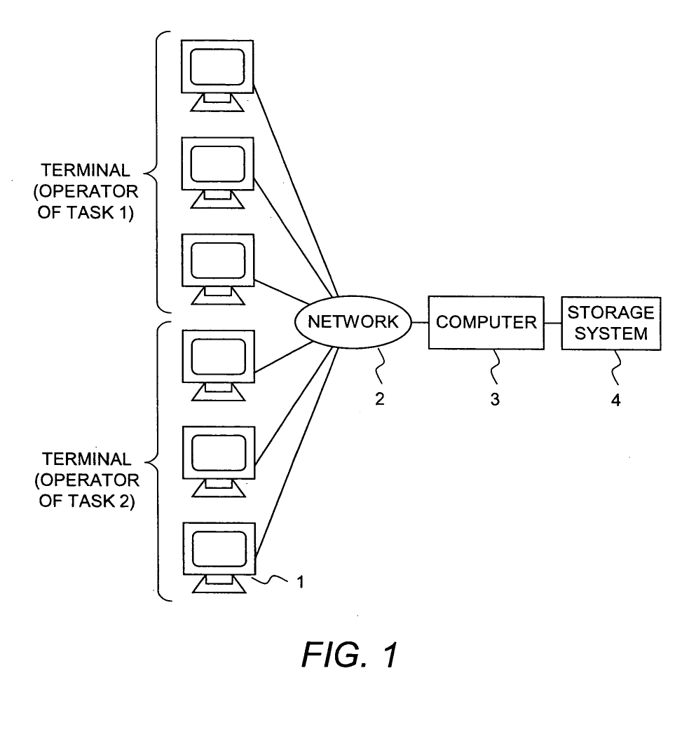

FIG. 1 is a block diagram showing a configuration of a computer system according to an embodiment of the present invention.

Plural terminals 1 to be used by operators of task 1 and plural terminals 1 to be used by operators of task 2 are connected to a computer 3 via a network 2. The computer 3 is connected to a storage system 4.

The computer 3 includes a CPU (Central Processing Unit) to perform processing and a memory used by the CPU. Plural tasks are executed in the CPU by operation from the terminal 1.

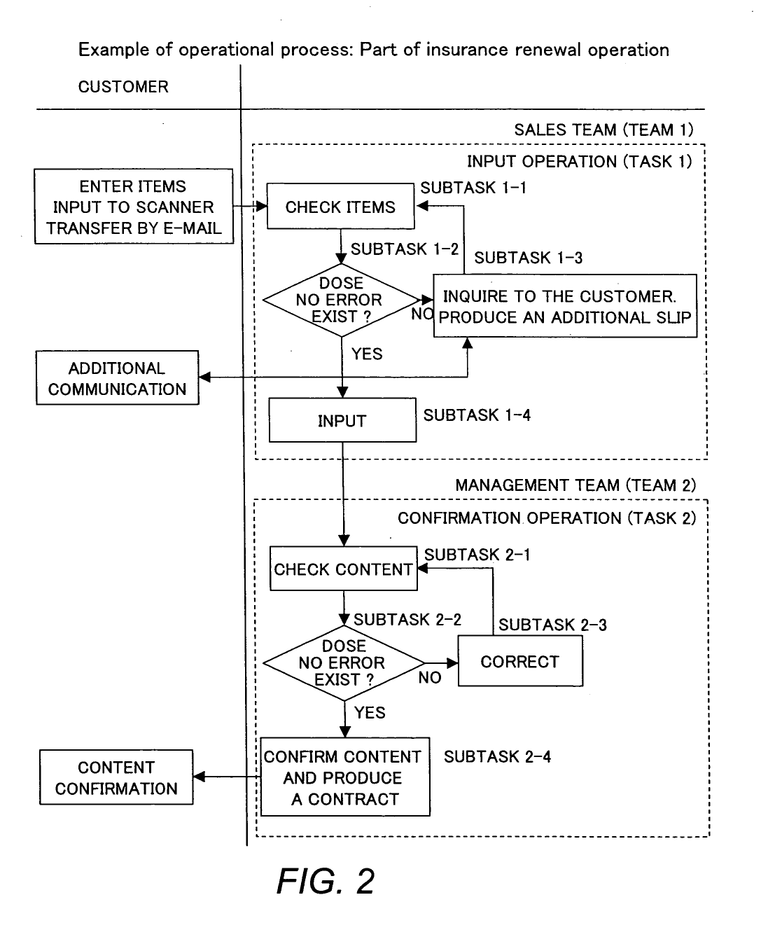

FIG. 2 is a flowchart of operational process, e.g. an insurance renewal operation, performed in a computer system according to an embodiment of the present invention.

A scanner reads a slip in which items necessary for an insurance renewal have been entered by a customer. Then an OCR (Optical Character Reader) converts the data read by the scanner into electronic data. Instead of the slip, data transmitted by e-mail may be used.

Subsequently, a sales team (team 1) performs an input operation (task 1) to input the data entered by the customer as contract information.

First in the input operation (task 1), the items entered by the customer are checked (subtask 1-1). Next, based on the results of the item checking, whether or not there is any error in the information entered by the customer is confirmed (subtask 1-2). If any error exists, a relevant inquiry is made to the customer. When the customer provides additional information, an additional slip is made out (subtask 1-3). The processing then returns to the item checking (subtask 1-1).

When no error exists in the information entered by the customer, the information is inputted as contract information (subtask 1-4). Then the input operation is completed (task 1).

The operation is subsequently taken over by a management team (team 2) which performs confirmation operation (task 2) in which a contract is produced from the input contract information.

First in the confirmation operation (task 2), the content of the contract information inputted by the sales team is checked (subtask 2-1). Next, based on the results of the check, whether or not there is any error in the contract information inputted by the sales team is confirmed (subtask 2-2). If any error exists, the error is corrected (subtask 2-3) and the processing then returns to the content check (subtask 2-1).

When no error exists in the contract information inputted by the sales team, the contract information is confirmed and a contract is executed (subtask 2-4). Then the confirmation operation is completed (task 2).

Subsequently, the contract is sent to the customer. The customer confirms content of the contract upon receiving the contract.

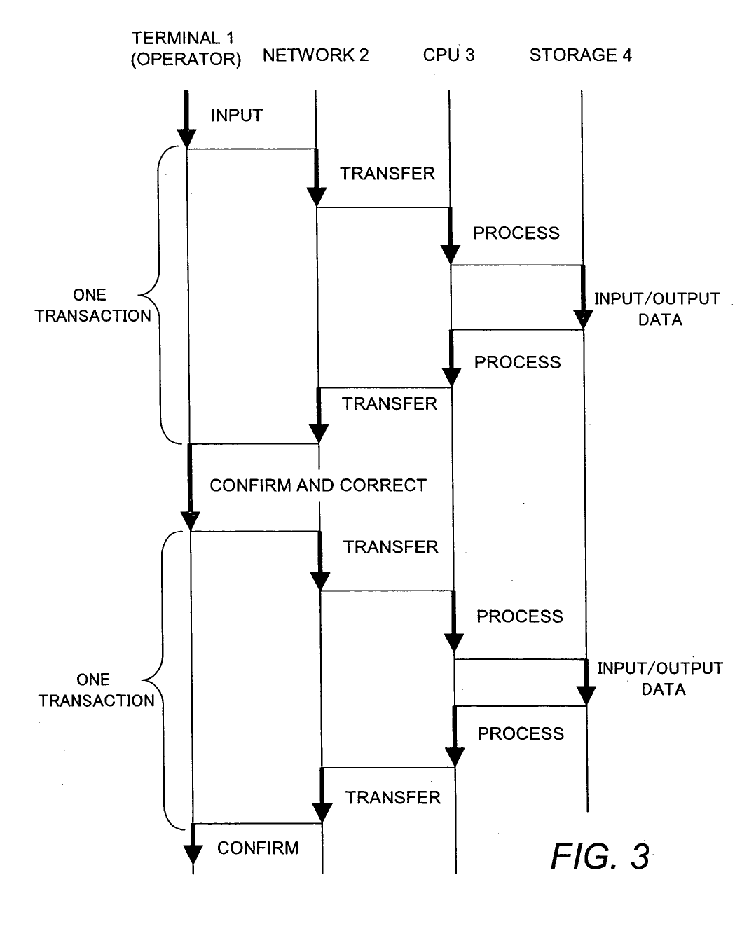

FIG. 3 shows an example of information flow during task execution in a computer system according to an embodiment of the present invention.

When operator inputs information into the terminal 1, the information is transferred to the computer 3 via the network 2. The computer 3 processes the information received. Inputting (writing) and outputting (reading) of data to and from the storage system 4 then take place. Subsequently, the data (or a write complete response) outputted from the storage system 4 is sent to the computer 3. The computer 3 processes the data received. The result of the processing is transferred to the terminal 1 via the network 2. One transaction (e.g. an item checking operation (subtask 1-1)) is completed up to this process.

After the output information is subsequently checked and corrected as required by the operator, another transaction (for example, an input operation (subtask 1-4)) is started. The transaction started follows the same course of processing by the preceding transaction: transferring information via the network 2, processing by the computer 3, data input and output to and from the storage system 4, processing by the computer 3 and transferring information via the network 2. Then the operator performs information checking at the terminal 1.

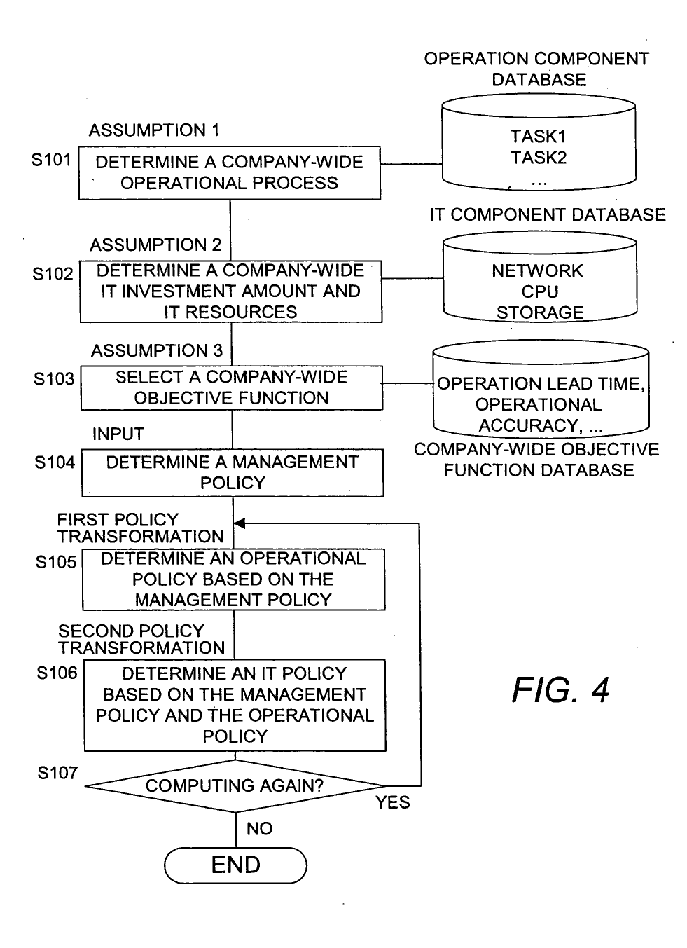

FIG. 4 is a flowchart showing how an IT policy (information system operating policy) is determined in a computer system according to an embodiment of the present invention.

First, a company-wide operational process is determined as assumption 1 (S101). For example, the operations (tasks) to compose the company's operational process are determined. Next, the amount of the company's IT investment and the IT resources of the company are determined as assumption 2 (S102). Performance of the IT resources made up of a network, a server, and a storage system is determined as assumption 2. The order of determining assumptions 1 and 2 is optional.

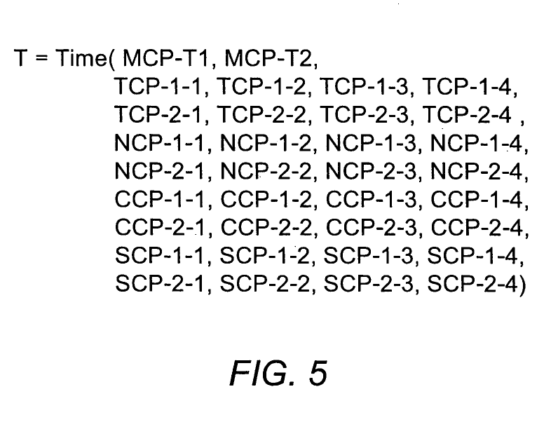

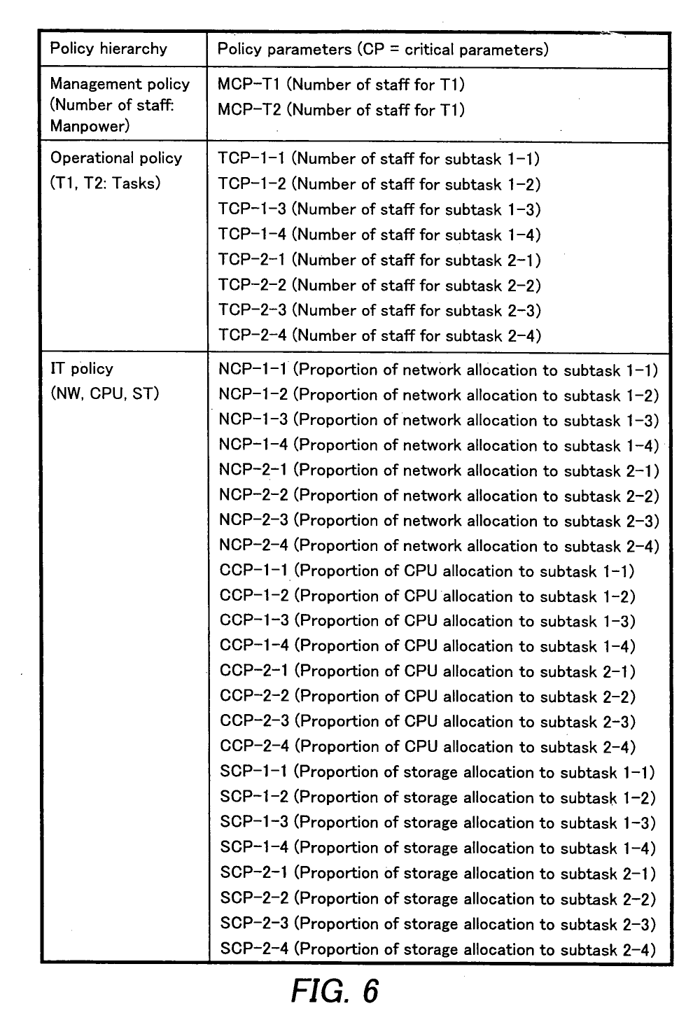

An operational objective function is then selected as assumption 3 (S103) from an operational objective function database. For example, an operation lead time function (see FIG. 5 and FIG. 6) which optimizes an objective indicator, for example, an operation lead time is selected. An operation lead time is derived when such parameters as management policy parameters (MCP-T1 and MCP-T2), operational policy parameters (TCP-1-1 to TCP-2-4), and IT policy parameters (NCP-1-1 to NCP-2-4, CCP-1-1 to CCP-2-4, and SCP-1-1 to SCP-2-4) are assigned to the operation lead time function. More specifically, a function composition method described in JP 2000-276454A may be used.

Other objective indicators than the operation lead time may be used. For example, operational accuracy, operational cost, profit, sales amount, per capita profit, and per capita sales amount may be used either singularly or in combination as objective indicators.

Next, a management policy is determined (S104). The management policy is assigned as a resource to be used in each operation. A policy of, for example, giving priority to operational processing for a particular merchandise article may also be adopted as a management policy.

Next, using the operational objective function selected in step S103, a first policy transformation is performed (S105) to determine an operational policy based on the management policy (S105). Furthermore, also using the operational objective function selected in step S103, a second policy transformation is performed (S106) to determine an IT policy based on the management policy and the operational policy determined in step S104.

Subsequently, whether or not to compute the IT policy again is determined (S107). When it is necessary to continue computation, the processing returns to step S105. In step S105, the first policy transformation is performed to determine an operational policy using the management policy inputted in step S104 and the IT policy determined by the second policy transformation as parameters. Furthermore, the second policy transformation is performed (S106) to determine an IT policy using the management policy and the operational policy determined in step S104.

FIG. 6 shows an example list of parameters defining a management policy, an operational policy, and an IT policy.

A management policy is inputted in step S104 shown in FIG. 4. The management policy defines human resources for individual divisions. More specifically, it defines the number of operation-1 staff members (MCP-T1) and the number of operation-2 staff members (MCP-T2). The management policy may be weighted by a weighting factor based on the capability of staff. Such a weighting factor may be determined for each staff member or for each division taking into account the divisional operating efficiency.

An operational policy is determined by the first policy transformation (S105 in FIG. 4). The operational policy provides parameters for use in the second policy transformation (S106 in FIG. 4). The parameters define human resources for each divisional subtask. Like in the case of a management policy, the operational policy may be weighted by a weighting factor based on the capability of staff.

Initial values of an IT policy are used as parameters in the first policy transformation (S105 in FIG. 4). The IT policy values are finalized in the second policy transformation (S106 in FIG. 4). The parameters composing the IT policy define IT resources available for each subtask. In the present embodiment, the IT resources include the network 2, the computer 3, and the storage system 4, and the IT policy defines the proportion of allocation of each of the IT resources to each subtask.

The proportions of network allocation, for example, define the proportions of packets transferred via the network 2. More specifically, when the proportions of network allocation to transactions A and B are assumed respectively 70% and 30%, and the two transactions simultaneously use the network, the network bandwidth is controlled so as to transfer seven packets for transaction A and then three packets for transaction B.

The proportions of computer allocation define the number of instructions processed by the CPU included in the computer 3. More specifically, when the proportions of CPU allocation to transactions A and B are assumed respectively 70% and 30%, and the two transactions simultaneously use the CPU, the CPU is controlled such that it processes seven instructions for transaction A and then three instructions for transaction B. The proportions of computer allocation may define the proportions of utilization, by tasks, of the memory included in the computer 3.

The proportions of storage allocation define the number of data blocks processed in the storage system 4 in a unit amount of time. More specifically, when the proportions of storage allocation to transactions A and B are respectively 70% and 30%, and the two transactions simultaneously use the storage resource, the storage operation is controlled such that seven blocks of data are processed for transaction A and then three blocks of data are processed for transaction B. The proportions of storage allocation may define the proportions of occupancy, by tasks, of the disk storage capacity of the storage system 4.

Next, the policy transformations according to an embodiment of the present invention will be described in concrete terms.

As an example, assume a case in which IT resources and an operational process, and an operational process objective are fixed. In the first policy transformation (S105 in FIG. 4) to convert a management policy into an operational policy, a management policy (MCP-T1 and MCP-T2) is inputted and then, based on the assumption that all the allocation proportions defined by the IT policy (NCP-1-1 to SCP-2-4) are equal, an operational policy (TCP-1-1 to TCP-2-4) is determined by the method of least squares so that the operation lead time function T is minimized. In this process, initial values of the resource allocation proportions (for example, values desired for individual operations) may be inputted for the IT policy instead of using the above assumption.

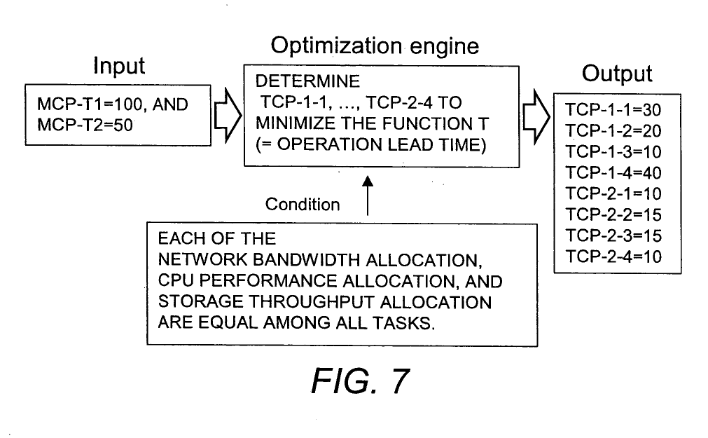

More specifically, as shown in FIG. 7, the management policy parameters MCP-T1 and MCP-T2 are set to 100 operators and 50 operators, respectively. A condition imposed by an IT policy that each of the network bandwidth allocation, the CPU performance allocation, and the storage throughput allocation is equal among all tasks is assigned. Then the operational policy parameters (TCP-1-1 to TCP-2-4) are determined by the least-square method so that the operation lead time function T is minimized. As a result, an operational policy (operators allocation among subtasks), for example TCP-1-1=30 operators, . . . , TCP-2-4=10 operators, is obtained.

Next, in the second policy transformation (S106 in FIG. 4) to convert the operational policy into an IT policy, a management policy (MCP-T1 and MCP-T2) and the operational policy (TCP-1-1 to TCP-2-4) are inputted and then an IT policy (NCP-1-1 to SCP-2-4) is determined by the least-square method so that the operation lead time function T is minimized.

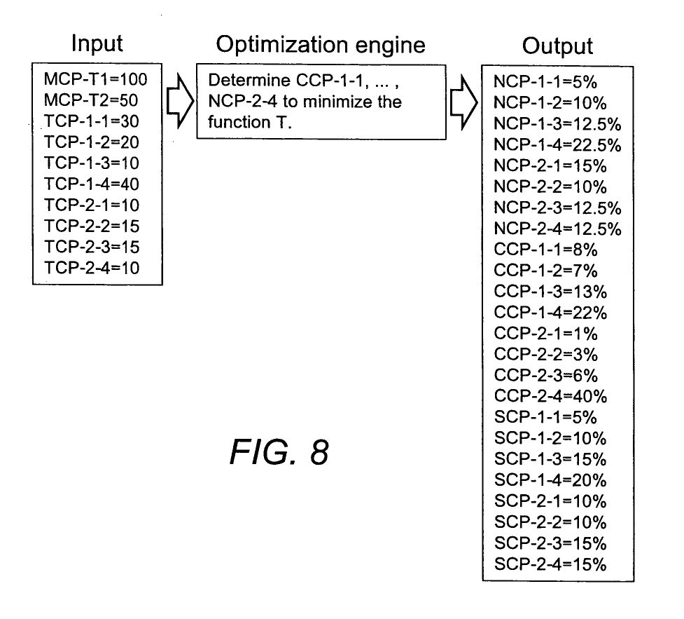

More specifically, as shown in FIG. 8, the operational policy (TCP-1-1=30 operators, . . . , TCP-2-4=10 operators) computed in the first policy transformation is inputted and an IT policy (NCP-1-1 to SCP-2-4) is determined by the least-square method so that the operation lead time function T is minimized. As a result, an IT policy like, for example, [NCP-1-1=5%, . . . , SCP-2-4=15%] is obtained. In the example shown in FIG. 8, only an operation policy is inputted with no management policy inputted. In this case, the sum of the operational policy parameters for all divisions is made a management policy.

As described above, in an embodiment of the present invention, parameters of three policies, i.e., a management policy, an operational policy, and an IT policy are defined based on a hierarchical-policy concept. Next, an operational objective function for achieving a company-wide operational objective (for example, an operation lead time) is determined. Subsequently, an operational process is fixed and, using a management policy (human resource allocation among divisions) as input data and based on the assumption that the IT resource allocation (priority for resource utilization) is equal among all operations to use the operational process, resource allocation among divisions to optimize the operational objective function is computed (first policy transformation). Following the first policy transformation, using the management policy and the resource allocation among divisions as input data, IT resource allocation to optimize the operational objective function is determined (second policy transformation). In this way, IT resource allocation accurately reflecting a management policy can be determined. Thus, even if a management policy is frequently changed, it is possible to operate and operate an IT system to support the operations.

Since an IT policy is optimized by the second policy after the operational policy parameters are defined by the first policy, finer optimization of the IT policy is achieved.

The present invention can be applied to a system for restructuring an information system infrastructure of an enterprise to enable the enterprise to flexibly cope with changes in management policy, an operation management middleware to operate and manage an IT system based on a management policy, and an IT assessment system reflecting a management policy.

Rather than for the purpose of determining an intra-enterprise IT policy, the present invention can also be applied to an inter-enterprise information system to be capable of coping with changes in business practice between enterprises and to an information system which is used between administrative agencies or between administrative agencies and enterprises and which is required to be capable of coping with changes in national policy.

While the present invention has been described in detail and pictorially in the accompanying drawings, the present invention is not limited to such detail but covers various obvious modifications and equivalent arrangements, which fall within the purview of the appended claims.

1. A method for determining IT resources allocation of an IT system, which are shared by divisional operations of an organization based on management resources allocation among divisions in the organization, the method comprising:
a first step of determining, so as to optimize a value of an operational objective, management resource allocation for each of the divisional operations based on the assumption that IT resource allocation is equal among the divisional operations and based on the management resource allocation of the divisions in the organization; and
a second step of determining, so as to optimize the value of the operational objective, IT resource allocation for each of the divisional operations based on the management resource allocation for each of the divisional operations determined by the first step.

2. The method for determining allocation of IT resources according to claim 1, wherein management resource allocation for each of the divisional operations is again determined by the first step using the IT resource allocation determined by the second step and then the IT resource allocation for each of the divisional operations is redetermined by the second step.

3. The method for determining allocation of IT resources according to claim 1, wherein the value of the operational objective includes at least one of an operation lead time, an operational accuracy, an operational cost, a profit, a sales amount, a per capita profit and a per capita sales amount, and wherein the value of the operational objective is computed using an objective function predetermined for the organization.

4. The method for determining allocation of IT resources according to claim 1, wherein the management resources include a number of staff members in each division.

5. The method for determining allocation of IT resources according to claim 1, wherein the management resources include a number of staff members in each division weighted by a capability.

6. The method for determining allocation of IT resources according to claim 1,
wherein the IT resources comprise a network to which a plurality of terminals are connected, a computer to perform processing, and a storage system storing data used for the processing; and
wherein the IT resource allocation comprises allocating at least one of a network bandwidth, CPU usage in the computer, memory usage in the computer, and throughput of the storage system.

7. A computer system which comprises a computer performing processing, a network to which the computer and a plurality of terminals are connected, and a storage system storing data used for the processing performed by the computer and which is shared by divisional operations of an organization, the system comprising:
a first policy transformation module determining, so as to optimize a value of an operational objective, management resource allocation for each of the divisional operations based on the assumption that IT resource allocation is equal among the divisional operations and based on management resources allocation of divisions in the organization; and
a second policy transformation module determining, so as to optimize the value of the operational objective, IT resource allocation for each of the divisional operations based on the management resource allocation for each of the divisional operations determined by the first policy transformation module,
wherein the first policy transformation module and the second policy transformation module determine IT resource allocation of the computer system.

8. The computer system according to claim 7, wherein the first policy transformation module again determine management resource allocation for each of the divisional operations by using the IT resource allocation determined by the second policy transformation module and then the second policy transformation module redetermine the IT resource allocation for each of the divisional operations.

9. The computer system according to claim 7, wherein the value of the operational objective includes at least one of an operation lead time, an operational accuracy, an operational cost, a profit, a sales amount, a per capita profit and a per capita sales amount, and wherein the value of the operational objective is computed using an objective function predetermined for the organization.

10. The computer system according to claim 7, wherein the management resources include a number of staff members in each division.

11. The computer system according to claim 7, wherein the management resources include a number of staff members in each division weighted by a capability.

12. The computer system according to claim 7, wherein the IT resource allocation comprises allocating at least one of a network bandwidth, CPU usage in the computer, memory usage in the computer, and throughput of the storage system.
